(19) United States
(12) Patent Application Publication
(10) Pub. No.: US 2026/0138756 A1
(43) Pub. Date: May 21, 2026

(54) SATELLITE APPARATUS AND METHOD FOR IMAGING SPACE OBJECTS

(71) Applicant: VYOMA GMBH, Muenchen (DE)

(72) Inventors: Christoph BAMANN, Muenchen (DE); Adrian BITTNER, Muenchen (DE)

(21) Appl. No.: 19/121,853

(22) PCT Filed: Sep. 9, 2024
(86) PCT No.: PCT/DE2024/100790

§ 371 Date: Apr. 17, 2025

(30) Foreign Application Priority Data
Sep. 25, 2023 (DE) 10 2023 125 956.3

(51) Int. Cl. B64G 1/10; B64G 1/24; B64G 1/36; G02B 23/00; H04N 23/695; H04N 23/73

(52) U.S. Cl. CPC B64G 1/105; B64G 1/244; B64G 1/36; H04N 23/695; H04N 23/73; G02B 23/00

(57) ABSTRACT

The invention relates to a satellite apparatus (100, 200) for imaging space objects (116, 116′), wherein the satellite apparatus (100, 200) is movable along an orbit (102) with a position-dependent orbital coordinate system (104), the satellite apparatus (100, 200) being movable along an orbit (102) with a position-dependent orbit coordinate system (104) (110, 110′, 218) and an imaging telescope sensor (210) that is arranged and configured to generate images (132) of space objects (116, 116′) in front of the starry background, and a control device (204) that is adapted to control the satellite apparatus (100, 200) in such a way that, in the intended operation, a predetermined pitch angle (114) is set between the telescope axis (110, 110′, 218) and the orbit axis (106), and to control the telescope sensor (210) such that streak images (132, 134) of space objects (116, 116′) and stars are continuously generated in order to obtain a plurality of streak images (132, 134) for generating a space object position map.

The invention relates to a satellite apparatus and a method for imaging space objects, in particular in low Earth orbit, to generate a space object position map.

The imaging of space objects and the observation and mapping thereof is known in principle. Telescopes and radar stations stationed on Earth are used to observe space objects, in particular space debris and satellites. Space objects, in particular space debris, are an unwanted by-product of space travel because they can obstruct space travel and cause damage on the ground.

More than 55,000 recorded and catalogued space objects with a diameter of more than 10 cm orbit the earth. Based on statistical models, the ESA indicates that there are more than 1 million objects larger than 1 cm in near-Earth space. Such space objects can collide with active satellites or space shuttles and, due to the high speeds involved, usually cause considerable damage. The pieces in Earth orbit that are detected and catalogued by telescopes and radar stations stationed on Earth do lead to a better understanding of space objects in Earth orbit, but they are insufficient for commercial space flight because smaller pieces also need to be detected and, in particular, a higher temporal resolution is required. Furthermore, the spatial resolution of this approach is usually insufficient, since no or only limited observation is possible, especially at high latitudes.

One approach to observing space objects using telescopes is known as staring. Staring involves keeping a fixed alignment with the starry background during the image exposure. As a result, the stars appear as points in the image, while less distant objects, such as space objects in Earth orbit, generate a linear signal in the image due to the relative motion, the length and shape of which result from the image exposure time.

Another approach is known as tracking. In tracking, the space object of interest is tracked with the optical axis of the telescope, so that the object movement in the image is minimized. The space object of interest generates a point-shaped signal in a first approximation, while the star background is imaged with line-shaped image elements. One disadvantage of tracking is that only a single object can be observed during an observation interval. Furthermore, the field of view has to be moved to another object between two observation intervals, which is why a low throughput of observed objects is another disadvantage of tracking. In addition, the orbit of an object to be observed should be approximately known a priori.

Due to the necessity of regular tracking movements, angular accelerations during staring and tracking during image integration lead to non-constant signal movements in the image, so that no accurate measurements, in particular astro- and/or photometric measurements, can be derived from the image data. Thus, among other things, correction movements effectively result in a loss of observation time. In general, the staring and tracking lead to a complex operation of the observation system or the satellite, which is particularly due to a position control and regulation, for example for tracking, as well as an alignment of the antennas to the ground station and/or the solar panels to the sun.

When observing space objects using a telescope on a satellite, previous approaches usually involve optimizing the observation situation with respect to an object to be observed, for example, by using a minimal sun phase angle. This is usually associated with a suboptimal number of objects to be observed.

The publication by Krag, H., et al. ‘Space based optical observation of small debris objects.’ Space Debris. Vol. 473. 2001 discloses a satellite-based observation of space debris using a telescope. A disadvantage of this approach is that, at least in certain areas of one's own orbit and in certain orbital regimes of the objects of interest, few or no observations can be detected.

CN105910583A discloses a method for detecting space debris.

It is therefore an object of the invention to provide a satellite apparatus and a method for imaging space objects that alleviate or eliminate one or more of the disadvantages mentioned. In particular, it is an object of the invention to provide a solution that enables a high detection frequency of a high number of space objects in orbits around the Earth. Furthermore, it is an object of the invention to provide a solution that enables the detection of particularly small space objects in orbits around the Earth.

This problem is solved by means of a satellite apparatus and a method according to the features of the independent claims. Further advantageous embodiments of these aspects are indicated in the respective dependent claims. The features disclosed in the claims, the description and the drawings can be combined with each other individually, in any technologically meaningful way, whereby further embodiments of the invention are indicated.

According to a first aspect, the above-mentioned problem is solved by a satellite apparatus for imaging space objects, in particular radiation-emitting space objects, preferably in low-Earth orbit, for generating a space object position map, wherein the satellite apparatus is movable along an orbit with a position-dependent orbit coordinate system that having an orbital axis, a gravitational axis and a pitch axis, the satellite apparatus comprising a telescope apparatus having a field of view, a telescope axis and an imaging telescope sensor that is arranged and configured to produce images of space objects in front of the star background, and a control device that is adapted to control the satellite device such that in its intended operation a predetermined pitch angle is set between the telescope axis and the orbit axis, and to control the telescope sensor such that streak images of space objects and stars are continuously generated in order to obtain a multiplicity of streak images for generating a space object position map.

In a preferred embodiment, the control device is adapted to control the satellite apparatus such that the pitch angle is constant. In particular, the pitch angle is constant within an observation interval.

Alternatively or in addition, it is preferred that the control device is adapted to control the satellite apparatus such that the pitch angle is set within a pitch angle range. The pitch angle range can, for example, extend between +20° and −20°, in particular between +4° and −12°. An advantage of this embodiment is that the orbit stations to be observed can be focused.

Alternatively or in addition, it is preferred that the control device is adapted to control the satellite apparatus such that the telescope axis moves relative to the orbit axis in the pitch direction and/or the telescope axis oscillates relative to the orbit axis at a predefined angular velocity in the pitch direction. An advantage of this embodiment is that a large number of orbital planes and a large number of different particle sizes can be observed. The angular velocity of the oscillating motion can, for example, be between 2°/min and 6°/min.

The invention is based on the realization that space objects can be advantageously detected using a satellite-based telescope when the telescope axis is aligned in a defined manner relative to the horizon, for example always in the same direction or with a predetermined oscillation, so that the telescope is guided essentially free of acceleration in order to produce optimal images. The feeder of the telescope is essentially free of acceleration, because, for example, in the case of the predetermined oscillation, a rapid reversal of movement is required at the reversal points.

This results in the space objects as such, as well as the stars in the background, being depicted as streaks, whereby such streak images can be evaluated advantageously and the space objects in particular can be recognized. This results in a high detection frequency of a large number of space objects in all orbits. As a result, a comprehensive space situational awareness picture can be provided that can be used for the safe and automated operation of other satellites. Furthermore, the streak images and the selection of an optimal pitch angle can be used to adjust the signal-to-noise ratio as required.

The invention is also based on the realization that it represents a middle way between various optimization objectives in order to see as many objects as possible. Among other things, non-optimal, in particular larger, solar phase angles can be considered in order to align the field of view to regions of high object density that are not in the Earth's shadow by means of a uniform positional movement.

The invention is further based on the finding that the predetermined pitch angle can be used to direct the field of view to regions of high object density while simultaneously enabling a favorable sun phase angle and/or contrast, so that the detectable field of view passes are optimized. Meanwhile, the uniformity of movement can be advantageously used for illumination and to extract accurate measurement values.

The satellite apparatus is configured to image space objects. In particular, this involves an optical imaging of the space objects with an optical telescope sensor. The imaging of the space objects is carried out in particular by means of the radiation emitted by the space objects, for example by reflecting solar radiation. The satellite apparatus is in particular being arranged and configured to monitor an orbit in a near-Earth space, for example the Low Earth Orbit (LEO). Furthermore, the satellite apparatus can also detect space objects in higher orbit planes.

The satellite apparatus can be moved along an orbit, in particular around the Earth. At any point in the orbit, the orbital coordinate system is clearly defined. The orbital coordinate system is oriented to the current flight path. The orbital coordinate system is also referred to as the local frame. The orbit coordinate system is defined by the orbital axis, the gravitational axis and the pitch axis.

The orbital axis describes the direction of the orbit at any point on the orbit and is therefore aligned in the direction of the tangent. The gravitational axis is the axis at any point on the orbit that leads to the center of the earth. The gravitational axis is essentially parallel to a position vector of the satellite apparatus. The pitch axis is orthogonal to the orbital axis and the gravitational axis. The pitch angle and a corresponding pitch motion occur particularly in a plane with a pitch direction that is spanned by the orbital axis and the gravitational axis. The yaw angle and the corresponding yaw motion, which will be explained in more detail below, occur in particular in a plane defined by the orbit axis and the pitch axis.

The satellite apparatus comprises the telescope apparatus with the field of view. The field of view can be configured conically and/or pyramidal around the telescope axis. The telescope apparatus further comprises the imaging telescope sensor, which can be, for example, a CCD sensor or a CMOS sensor. In the intended operation of the satellite apparatus, the telescope axis is preferably aligned, inter alia, in a section located between the orbit and the earth. The telescope axis is thus regularly configured as a secant with respect to the orbit and the pitch angle is negative. Furthermore, a positive pitch angle can also be set.

The satellite apparatus further comprises the control device, which is adapted to control the satellite apparatus such that a constant pitch angle is set between the telescope axis and the orbit axis during intended operation. Due to the constant pitch angle, the satellite apparatus generally does not perform any movement in the orbital coordinate system.

The control device is preferably arranged and configured to provide a correction command, in particular to a position control unit described below, so that the telescope axis and the orbit axis maintain the constant pitch angle. In particular, the correction command is configured such that it causes the position control unit to influence the satellite apparatus in such a way that the constant pitch angle is maintained and/or set.

With respect to the orbital coordinate system, no pitch motion takes place at a constant pitch angle, since the constant pitch angle between the telescope axis and the orbit axis provides images of stars and space objects that are particularly easy to evaluate. In the case of the variant with a constant pitch angle, a pitch movement in the orbital coordinate system usually only takes place for corrections, since deviations from the pitch angle can occur due to disturbances. In the inertial system, on the other hand, a continuous pitch movement is performed so that the telescope axis is always aligned with the horizon. From the perspective of the satellite apparatus, the pitch movement is a change in the field of view up or down. In the variant with an adjustable pitch angle within the pitch angle range, the pitch movement occurs at defined times and/or positions along the orbit or continuously. This means, for example, that the focus can be directed to space objects at defined orbital altitudes and/or to space objects of different sizes and/or brightness classes.

The constant pitch angle between the telescope axis and the orbit axis ensures that the line of sight remains constant in relation to the Earth's horizon. The satellite apparatus is controlled such that in normal operation a constant pitch angle is set between the orbit and the telescope axis. In other words: in normal operation, the telescope axis forms a constant angle with the orbit.

In particular, in the intended use, this means that the satellite apparatus is in orbit and orbiting the earth.

The control device is further adapted to control the telescope sensor so that streak images of space objects and stars are continuously generated. Due to the movement of the satellite apparatus on the curved orbit and due to the constant pitch angle between the telescope axis and the orbit axis, space objects and stars are imaged in a streak-shaped manner for a correspondingly selected orbit, since there is always a relative movement between the telescope axis and the space objects or stars.

The fact that streak images of space objects and stars are continuously generated means, in particular, that exposures must be taken at short intervals. The invention is also based on the realization that streaks are easier to recognize in images than punctiform images of stars or space objects. In particular, due to the large number of space objects and stars, streak images are more easily analyzed than point images.

A satellite apparatus controlled in such a manner avoids the previous need for regular corrections or focusing during operation, so that a harmonious image can be generated on the basis of which space objects can be detected with a higher probability.

The satellite apparatus preferably comprises a solar cell unit that is arranged and configured to convert sunlight into electrical energy. The solar cell unit is further preferably arranged and configured to provide the electrical energy.

A preferred embodiment of the satellite apparatus provides that the control device is adapted to control the satellite apparatus such that the pitch angle is between +20° and −20°.

A negative pitch angle means that the telescope axis initially passes through a section located between the earth and the orbit. A pitch angle of 0° means that the telescope axis is aligned parallel to the orbit. A positive pitch angle means that the telescope axis is aligned away from the earth. The choice of the optimal pitch angle is always a compromise between an optimized field of view volume within a certain orbit height range, for example at a pitch angle between 0° and −5°, and a high noise component in the signal, for example at a pitch angle of −15° to −20°, since atmospheric influences increase the further the telescope is pointed towards the Earth, i.e. the larger the pitch angle. In particular, it is preferred that the pitch angle is between −12° and +4°.

In a preferred embodiment of the satellite apparatus, the control device is adapted to control the satellite apparatus such that the telescope axis performs a yaw motion about the gravitational axis so that the field of view can be aligned with at least one predetermined orbital regime. From the perspective of the satellite apparatus, the yaw motion of the telescope axis is a change in the field of view to the right or left. Thus, the field of view can be aligned to those orbital regimes in which a high density of space objects is to be expected, for example above the Earth's poles.

In a further preferred embodiment of the satellite apparatus, the control device is adapted to control the satellite apparatus such that a constant yaw angle is set between the telescope axis and the orbit axis in order to align the field of view with at least one predefined orbital regime.

In a further preferred embodiment of the satellite apparatus, the control device is adapted to control the satellite apparatus such that the telescope axis oscillates by means of the yaw motion in a predefined angular range around the gravitational axis, in particular oscillating discontinuously, wherein said yaw motion is performed at a first angular velocity in order to observe at least two predefined orbital regimes.

In particular, for orbits that do not pass directly over the Earth's poles, oscillation around the gravitational axis can be used to align the telescope axis to the region above the North Pole and above the region above the South Pole. Furthermore, the yaw motion is preferably chosen such that the solar phase angle is minimized, so that particularly small space objects can be observed. Preferably, the swinging is not continuous, but is performed at a fast angular velocity from a first orientation to a second orientation, in order to minimize the amount of disturbance introduced during image acquisition.

Another preferred embodiment of the satellite apparatus is characterized in that the control device is adapted to control the satellite apparatus such that the telescope axis is pivotable by 180° between a first orientation and a second orientation as a function of a solar phase angle by means of the yaw motion through 180° between a first orientation and a second orientation, so that the field of view can be aligned in dependence on a solar phase angle.

Although the imaging of space objects according to the invention does not necessarily require the telescope axis to be aligned away from the sun, it is still disadvantageous to look directly into the vicinity of the sun, since the space objects reflect no or only a small amount of radiation at a small angle of incidence. Therefore, this condition can be taken into account by a yaw movement of 180° between the first alignment and the second alignment, so that, for example, a corresponding side of the earth facing the sun can execute a pivoting movement.

Another preferred embodiment of the satellite apparatus is characterized in that the control device is adapted to control the telescope sensor such that an exposure time between 0.1 seconds and 2 seconds, in particular between 0.25 seconds and 1 second, preferably between 0.1 seconds and 0.5 seconds, in order to obtain evaluable streak images of space objects and stars.

It is particularly preferred that the control device is adapted to determine one or the exposure time such that a streak image of a space object can be imaged with 15 to 315 pixels, in particular 30 to 200 pixels, of the telescope sensor, and to control the telescope sensor with the exposure time.

As described above, the exposure time can, for example, be between 0.1 and 0.5 seconds. Images of a space object with 30 to 200 pixels have proven to be advantageous to evaluate.

In a further preferred embodiment of the satellite apparatus, it is provided that this comprises a position control unit that is signal-coupled to the control device and that is arranged and configured to change the orientation of the satellite apparatus with respect to the orbital coordinate system, so that a pitch movement and/or the yaw movement can be effected by activation of the position control unit.

In order to perform the pitch movement, the position control unit is configured in particular to provide the satellite apparatus with a one-time impulse so that the satellite apparatus continuously rotates with respect to the inertial system due to the essentially non-existent friction in space and thus the constant pitch angle is set between the orbit axis and the telescope axis. Furthermore, the position control unit is preferably configured to keep the pitch angle constant, for example by maintaining the correction signal. The control device is preferably adapted to detect a deviation of the pitch angle and to generate the correction signal. To achieve the yaw motion, specific impulses may be required by the position control unit.

Alternatively or in addition to the position control unit, the satellite apparatus can have an alignment device for the telescope, so that it is not the satellite apparatus itself that moves with respect to the orbital coordinate system, but the telescope.

In a further preferred embodiment of the satellite apparatus, it is provided that this comprises an analysis unit which is arranged and configured to analyze the streak images based on a star catalogue in order to detect space objects and at least one property of each of the space objects, and to generate a first data set representing the detected space objects and the property, and a transmitting unit, which is arranged and configured to transmit the first data set to a receiving unit located on the earth.

The property of the space objects can, for example, be a position in the image, a position in space, an orbit or a size of the space object. Furthermore, the property can be an apparent brightness of the space object. In addition, the property can be a state of rotation. Furthermore, the property can be a variation of the properties mentioned above. Furthermore, the property can be a size, a shape and/or a surface property of the space object.

For example, the transmitting unit can be configured as one, two or more antennas or comprise these.

In a further preferred embodiment of the satellite apparatus, it is provided that it comprises a compression unit that is arranged and configured to generate a second compressed data set representing the streak images, wherein the second compressed data set can be transmitted by means of one or the transmitting unit to a receiving unit located on the earth.

The advantage of the analysis unit is that the images can already be analyzed on the satellite apparatus and, if necessary, only text files, for example image coordinates in a specific format, preferably as encrypted binary data, are to be transmitted to the earth or the receiving unit. The amount of data is usually small. If an evaluation at the satellite apparatus is not appropriate, it may be necessary to compress the data in such a way that it can be transmitted securely to the receiving unit. In low-Earth orbit, for example, data can be transmitted to a single receiving unit in a time window of 10 to 15 minutes, so that the second data set should be of such a size that it can be transmitted to the receiving unit within this time.

According to a further aspect, the problem mentioned at the beginning is solved by a method for mapping space objects, comprising the steps of: moving a satellite apparatus along an orbit with a position-dependent orbital coordinate system that has an orbital axis, a gravitational axis and a pitch axis, the satellite apparatus comprising a telescope apparatus with a field of view, a telescope axis and an imaging telescope sensor for producing images of space objects in front of the star background, setting a predetermined pitch angle between the telescope axis and the orbit axis, and continuously producing streak images of space objects and stars to obtain a plurality of streak images for producing a space object position map.

It is preferred that the pitch angle is set to be constant. It is further preferred that the pitch angle is set within a pitch angle range. Furthermore, it may be preferred that the telescope axis moves relative to the orbit axis in the pitch direction and/or that the telescope axis oscillates relative to the orbit axis with a predefined angular velocity in the pitch direction.

In a preferred embodiment of the method, it is envisaged that this comprises the step of: setting a yaw angle, for example by performing a yaw motion, of the telescope axis about the gravitational axis, such that the field of view can be aligned with at least one predetermined orbital regime.

In a further preferred embodiment of the method, it is provided that the adjustment of the pitch angle and/or the performance of the yaw motion is effected by a change in the position of the satellite apparatus.

It is preferred that the satellite apparatus is controlled such that the pitch angle is between +20° and −20°, in particular between +4° and −12°.

It is further preferred that the method comprises the step of: setting a constant yaw angle between the telescope axis and the orbit axis. Furthermore, the method can comprise the step of: adjusting the telescope axis by means of the yaw motion in a predefined angular range around the gravitational axis, wherein this yaw motion is performed at a first angular velocity in order to observe at least two predefined orbital regimes.

In a further preferred embodiment of the method, it is provided that it comprises the step of: pivoting the telescope axis as a function of a solar phase angle by means of the yaw motion through 180° between a first orientation and a second orientation, so that the field of view is aligned as a function of a solar phase angle, in particular with respect to space objects in the field of view.

In a further preferred embodiment of the method, it is provided that it comprises the step of: controlling the telescope sensor such that an exposure time is between 0.1 seconds and 2 seconds in order to obtain evaluable streak images of space objects and stars.

In a further preferred embodiment of the method, it is envisaged that this comprises the step of: determining an exposure time such that a streak-shaped image of a space object is imaged with 10 to 80 pixels of the telescope sensor and controlling the telescope sensor with the exposure time.

In a further preferred embodiment of the method, this comprises the step of: evaluating the streak images based on a star map to detect space objects and at least one property of each space object and generating a first data set representing the detected space objects and the property. Furthermore, the method can comprise the step of: transmitting the first data set to a receiving unit located on the earth.

In a further preferred embodiment of the method, it is envisaged that this will comprise the step of: generating a compressed second data set representing the streak images, wherein the second data set is transmitted by means of one or the transmitting unit to a receiving unit located on the earth.

In a further preferred embodiment of the method, the satellite apparatus is moved in a sun-synchronous orbit at an altitude of 350 to 600 kilometers.

It is further preferred that the telescope axis be aligned such that there is a 90° angle between the telescope axis and a direction towards the sun. Furthermore, it is preferred that the angle between the telescope axis and the direction towards the sun is between 0° and 90°.

It is preferred that the telescope axis alternates between the angles 0° and 90°, in particular by means of the yaw motion. This realizes a pointing mode in which, during part of the orbit, a constant pitch motion with yaw angle=0° and thus a view in the orbital plane is performed, while the remaining part of the orbit, the solar phase angle is minimized via the yaw angle, for example yaw angle=90° at dawn-dusk in a sun-synchronous orbit.

For further advantages, design variants and design details of the individual aspects and their possible further developments, please also refer to the description given for the further aspects, the corresponding features and further developments.

Preferred embodiments are exemplified in the accompanying figures. Showing:

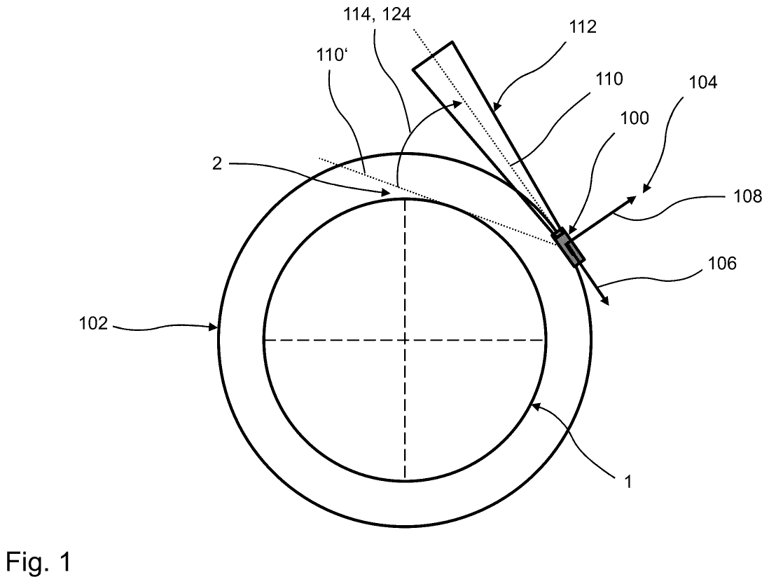

FIG. 1: a schematic, two-dimensional view of a satellite apparatus in low Earth orbit;

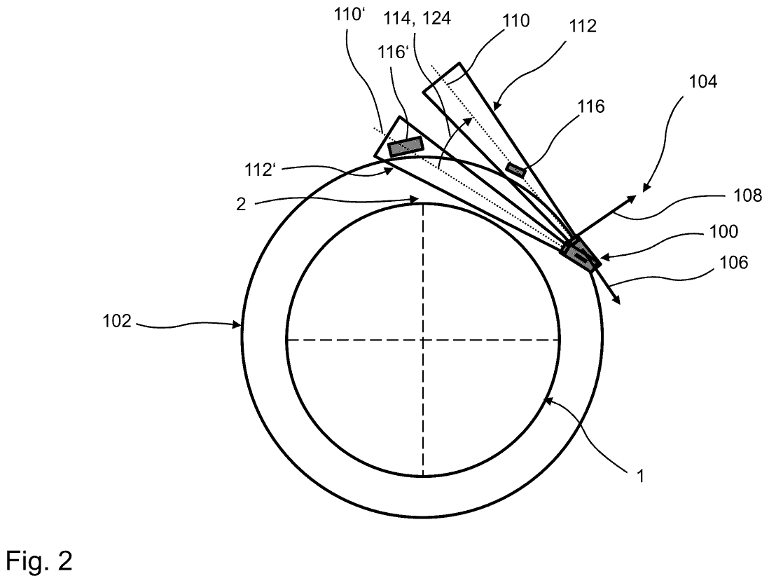

FIG. 2: a schematic, two-dimensional view of a satellite apparatus in low Earth orbit;

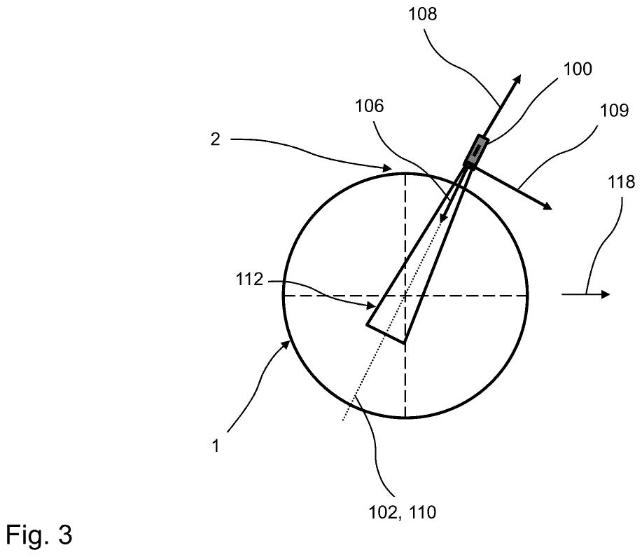

FIG. 3: a schematic two-dimensional view of a low-Earth orbit satellite apparatus;

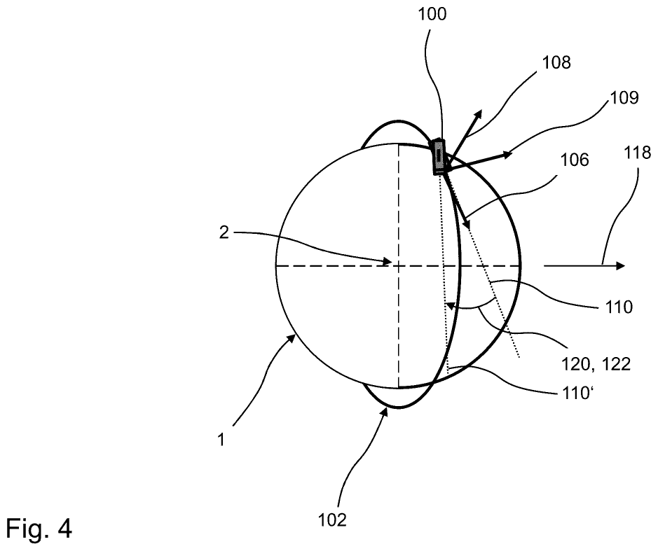

FIG. 4: a schematic three-dimensional view of an exemplary embodiment of a low-Earth orbit satellite apparatus;

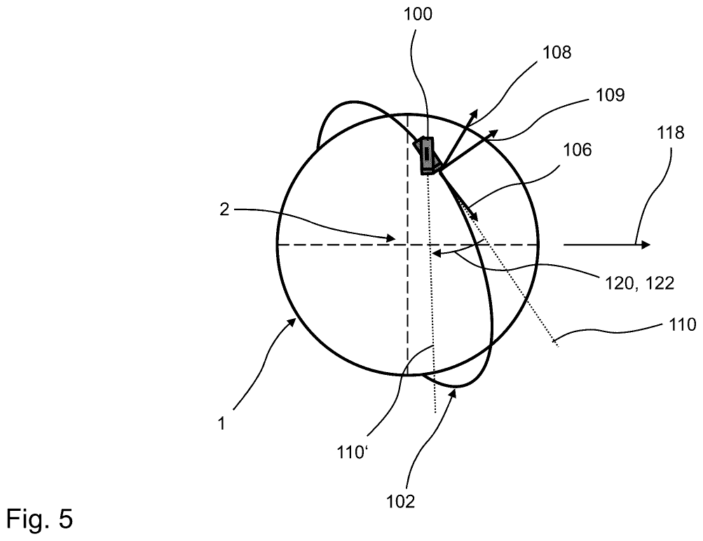

FIG. 5: a schematic three-dimensional view of an exemplary embodiment of a low-Earth orbit satellite apparatus;

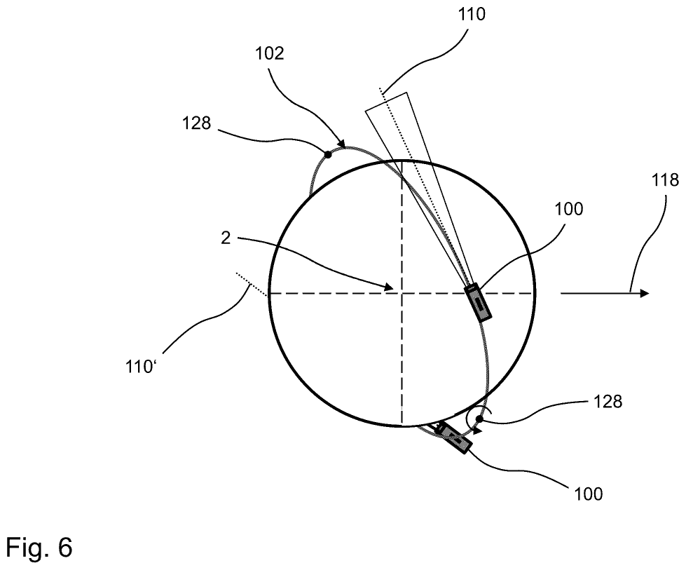

FIG. 6: a schematic, three-dimensional view of an exemplary embodiment of a satellite apparatus in low-Earth orbit;

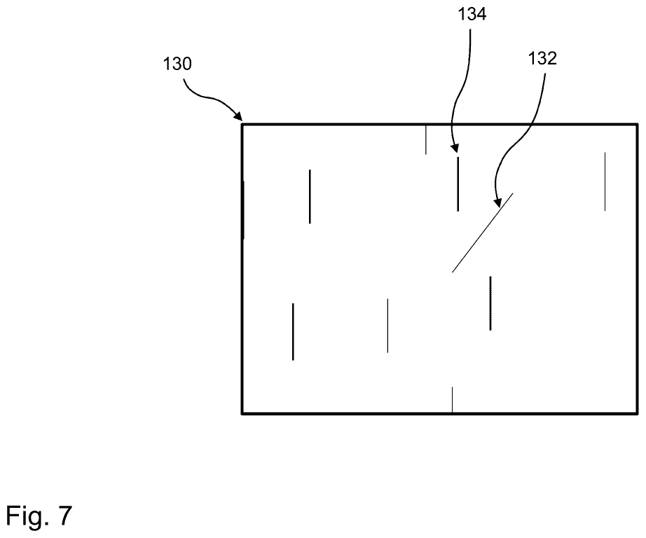

FIG. 7: a schematic, two-dimensional view of a mapping representation;

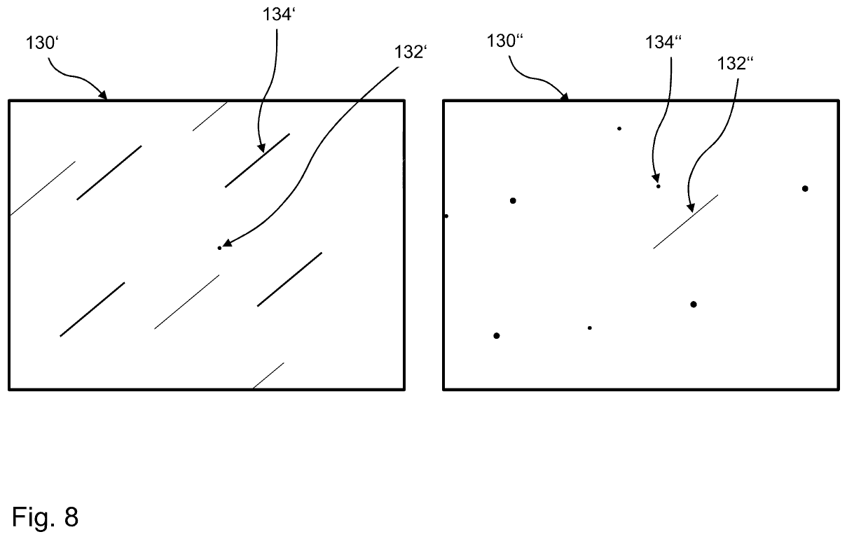

FIG. 8: schematic, two-dimensional representations of mapping representations using the tracking and staring methods;

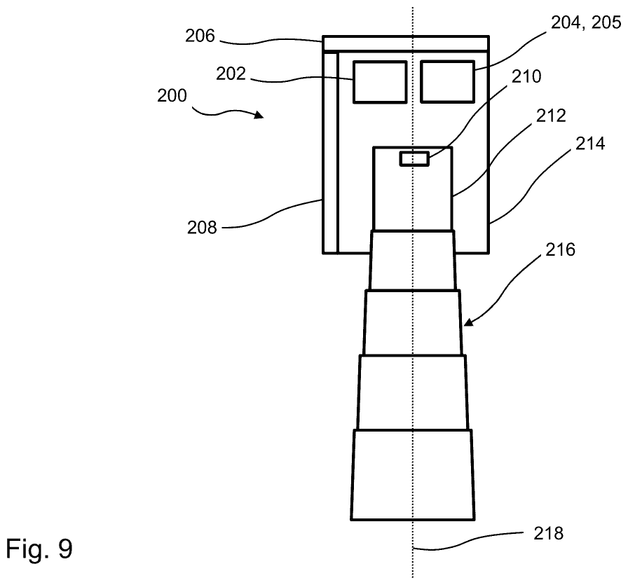

FIG. 9: a schematic, two-dimensional view of an exemplary embodiment of a satellite apparatus; and

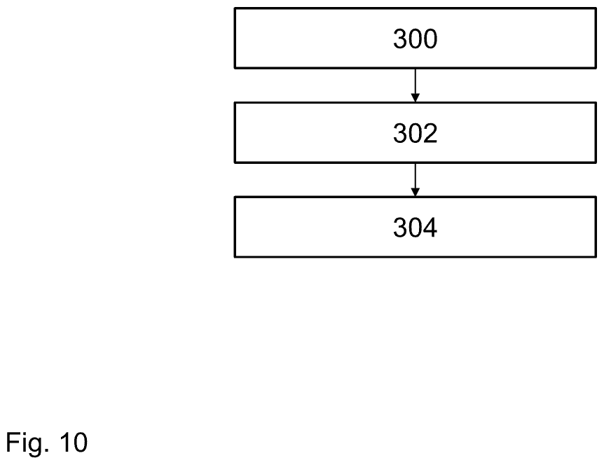

FIG. 10: a schematic representation of a method.

In the figures, identical or substantially identical or similar elements are designated by the same reference signs.

The examples explained below are preferred embodiments of the invention. In the examples, the components of the embodiments described represent individual features of the invention that are to be considered independently of each other, which further develop the invention independently of each other and are to be regarded as individual components of the invention or in a combination other than that shown. Furthermore, the described embodiments can also be supplemented by further features of the invention already described.

FIGS. 1 and 2 show views in which the pitch axis is perpendicular to the image plane, so that only the orbit axis 106 and the gravitational axis 108 of the orbit 102 are shown. In FIGS. 1 and 2, the origin of the orbit coordinate system 104 is shown to be at the satellite apparatus 100 in each case. The satellite apparatus 100 comprises a telescope apparatus with a telescope axis 110, which in FIG. 1 has a pitch angle of 0°, thus being aligned parallel to the orbit axis 106. The telescope also defines a field of view 112.

A second exemplary telescope axis 110′ is also shown, which is aligned directly with the Earth's horizon. The pitch angle 114 is set between the telescope axis 110′ and the orbit axis 106.

As the satellite apparatus 100 orbits clockwise around the Earth 1, it becomes clear that the satellite apparatus 100 continuously rotates in the image plane in order to set a constant pitch angle 114 between the telescope axis 110, 110′ and the orbit axis 106, since the orbit axis 106 moves continuously. In FIG. 1, the telescope is aligned against the direction of flight, so that a so-called backward pointing is set. Alternatively, a forward pointing can be set. Furthermore, the field of view is aligned in the direction of the North Pole 2, since there is usually an increased density of objects above the North Pole 2.

FIG. 2 also shows two space objects 116, 116′, where it can be seen that a downward-tilted field of view, with the telescope axis 110′, is larger than a field of view with a small pitch angle, here 0°, of the telescope axis 110, since the field of view 112′ covers a larger space of the low-Earth orbit.

FIG. 3 shows the position of the satellite apparatus 100, as shown in FIGS. 1 and 2, from a different perspective, as shown on the individual axes of the orbital coordinate system 104. In particular, the pitch axis 109, which is orthogonal to the orbital axis 106 and orthogonal to the gravitational axis 108, is shown. Furthermore, the direction of the sun 118 is shown here, whereby it is also shown that the field of view 112 is aligned away from the sun. Alternatively, the telescope axis 110, 110′ can enclose an angle of 90° with the direction of the sun 118. In FIGS. 1 and 2, the direction 118 of the sun is in the image plane.

FIGS. 4 and 5 show that the telescope axis 110 can be adjusted in a plane spanned by the orbit axis 106 and the pitch axis 109 by means of a yaw movement. In particular, a yaw angle can thus be set between the orbit axis 106 and the telescope axis 110 in the aforementioned plane. This means that the field of view can be aligned to the right and to the left, so that, for example, the object density ranges above the poles can be focused.

FIG. 6 shows that two points of rotation 128 can be defined at which the yaw movement performs a pivoting of the telescope axis 110 by 180° in dependence on a solar phase angle. In order to avoid the telescope axis 110 being aligned directly with the sun, the telescope axis 110 is rotated through 180° at the rotation points 128. A slight deviation from 180° is also possible. The rotation points 128 may, for example, be provided above or adjacent to the equator.

Alternatively or in addition, more than two points of rotation 128 can be defined, at which the telescope axis 110 is pivoted by a predetermined angle of rotation. The angle of rotation can be 180° or less and/or greater than 180°. The advantage of more than two points of rotation 128 can be that increased focus can be placed on areas of high object density. For example, with a forward pointing at the North Pole 2, the telescope can be moved to obtain images of the high object density area above the North Pole 2. At the North Pole 2, the telescope can be swiveled by 180° to continue obtaining images of the high object density area above the North Pole 2.

FIG. 7 shows a composite image 130 of streak images of space objects 132 and stars 134, which was created using the satellite apparatus 100 with the corresponding control system, as described above. Due to the constant pitch angle 114, the space object 132 and the stars 134 are equally represented in the form of lines.

To illustrate the difference compared to the known methods, FIG. 8 shows how the images of a tracking method are formed on the left and of a staring method on the right. In tracking, the space object 132′ is tracked with the telescope axis so that it is configured as a point and the stars 134′ are configured as lines. When staring, the telescope axis is aligned with the stars 134′, so that a space object 132′ is displayed as a line.

FIG. 9 shows a satellite apparatus 200. The satellite apparatus 200 can be configured in the same way as the satellite apparatus 100. The satellite apparatus 200 comprises an attitude control unit 202 that is arranged and configured to change an orientation of the satellite apparatus 200 with respect to the orbital coordinate system 104, so that the pitch motion 124 and the yaw motion 122 can be effected by a control of the attitude control unit.

Furthermore, the satellite apparatus 200 comprises the control device 204, which is adapted to control the satellite apparatus 200 in such a way that, in proper operation, a constant pitch angle 114 is set between the telescope axis 218 and the orbit axis 106 and to control the telescope sensor 210 such that streak-shaped images 132, 134 of space objects and stars are continuously generated in order to obtain a multiplicity of streak-shaped images 132, 134 for generating a space object position map.

The satellite apparatus 200 also comprises an analysis unit 205 which is arranged and configured to analyze the streak images 132, 134 based on a star map in order to detect space objects and at least one property of each of the space objects, and to generate a first data set representing the detected space objects and the property.

The satellite apparatus 200 further comprises two solar panels 206, 208 for generating electrical energy to supply the individual energy-consuming units of the satellite apparatus 200. The satellite apparatus 200 further comprises antennas 214 that are arranged and configured to communicate with a receiving station on the earth. In addition, the satellite apparatus 200 comprises the telescope 212, which comprises the telescope sensor 210 and a telescope diaphragm 216, in particular a lens hood.

FIG. 10 shows a method for imaging space objects 116, 116′. In step 300, the satellite apparatus 100, 200 is moved along the orbit 102 with a position-dependent orbit coordinate system 104 that has an orbital axis 106, a gravitational axis 108 and a pitch axis 109.

In step 302, a constant pitch angle is set between the telescope axis 110, 218 and the orbit axis 106.

In step 304, streak images 132, 134 of space objects and stars are continuously generated to obtain a plurality of streak images for generating a space object position map. Steps 300, 302 and 304 are performed completely or substantially in parallel.

With the satellite apparatus 100, 200 and the corresponding method described above, it is now possible to obtain an image representation 130 in which stars 134 and space objects 132 are represented in line form, so that it can be advantageously evaluated.

In particular, any 100, 200 orbits 102 can be selected by smart controlling the satellite apparatus, so that the number of required satellite apparatuses 100, 200 is reduced with a suitable constellation. This is made possible, among other things, by the fact that the telescope axis 110, 110′, 218 does not necessarily have to be aligned away from the sun.

REFERENCE SIGNS

| | |
|---|---|
| 1 | Earth |
| 2 | North Pole |
| 100 | Satellite apparatus |
| 102 | Orbit |
| 104 | Orbit coordinate system |
| 106 | Orbital axis |
| 108 | Gravitational axis |
| 109 | Pitch axis |
| 110, 110′ | Telescope axis |
| 112, 112′ | Field of view |
| 114 | Pitch angle |
| 116, 116′ | Space object |
| 118 | Direction of the sun |
| 120 | Yaw angle |
| 122 | Yaw motion |
| 124 | Pitch motion |
| 126 | Earth's axis |
| 128 | Point of rotation |
| 130, 130′, 130″ | Image display |
| 132, 132′, 132″ | Space object |
| 134, 134′, 134″ | Star |
| 200 | Satellite apparatus |
| 202 | Position control unit |
| 204 | Control device |
| 205 | Evaluation unit |
| 206 | Solar panel |
| 208 | Solar panel |
| 210 | Telescope sensor |
| 212 | Telescope |
| 214 | Antennae |
| 216 | Telescope diaphragm |
| 218 | Telescope axis |

1. A satellite apparatus for imaging space objects, the satellite apparatus being movable along an orbit having a position-dependent orbital coordinate system that is dependent on position, has an orbital axis, a gravitational axis and a pitch axis, the satellite apparatus comprising
a telescope device having a field of view, a telescope axis and an imaging telescope sensor that is arranged and configured to generate images (132) of space objects in front of the star background, and
a control device adapted to
control the satellite device such that in its intended operation a predetermined pitch angle is set between the telescope axis and the orbit axis, and
control the telescope sensor such that streak images of space objects and stars are continuously generated in order to obtain a plurality of streak images for generating a space object position map.

2. The satellite apparatus according to claim 1, wherein
the control device is adapted to control the satellite apparatus such that the pitch angle is constant.

3. The satellite apparatus according to claim 1, wherein
the control device is adapted to control the satellite apparatus such that the pitch angle is set within a pitch angle range.

4. The satellite apparatus according to claim 1, wherein
the control device is adapted to control the satellite apparatus such that the telescope axis moves in the pitch direction relative to the orbit axis and/or the telescope axis oscillates relative to the orbit axis at a predefined angular velocity in the pitch direction.

5. The satellite apparatus according to claim 1, wherein
the control device is adapted to control the satellite apparatus such that the pitch angle is set between +20° and −20°.

6. The satellite apparatus according to claim 1, wherein
the control device is adapted to control the satellite apparatus such that the telescope axis performs a yaw motion about the gravitational axis so that the field of view can be aligned with at least one predetermined orbital regime.

7. The satellite apparatus according to claim 1, wherein
the control device is adapted to control the satellite apparatus such that a constant yaw angle is set between the telescope axis and the orbital axis in order to align the field of view with at least one predefined orbital regime.

8. The Satellite apparatus according to claim 1, wherein
the control device is adapted to control the satellite apparatus such that the telescope axis yaw movement oscillates in a predefined angular range about the gravitational axis, wherein said yaw movement is performed at a first angular velocity in order to observe at least two predefined orbital regimes.

9. Satellite apparatus according to claim 1, wherein
the control device is adapted to control the satellite apparatus such that the telescope axis is pivotable in dependence on a solar phase angle by means of the yaw movement through 180° between a first orientation and a second orientation, so that the field of view can be aligned in dependence on a solar phase angle.

10. Satellite apparatus according to claim 1, wherein
the control device is adapted to control the telescope sensor such that an exposure time is between 0.1 seconds and 2 seconds, in particular between 0.25 seconds and 1 second, in order to obtain analyzable line images of space objects and stars.

11. Satellite apparatus according to claim 1, wherein
the control device is adapted to determine a or the exposure time such that a line-shaped image of a space object can be imaged with 10 to 80 pixels of the telescope sensor, in particular with 15 to 70 pixels, and
controlling the telescopic sensor with the exposure time.

12. Satellite apparatus according to claim 1, comprising
a position control unit that is coupled to the control device by signals and that is arranged and configured to change an orientation of the satellite apparatus with respect to the orbital coordinate system so that a pitch movement and/or the yaw movement can be effected by activation of the position control unit.

13. Satellite apparatus according to claim 1, comprising
an analysis unit which is arranged and configured to analyze the line images based on a star catalogue in order to recognize space objects and at least one property of each of the space objects, and to generate a first data set representing the detected space objects and the property, and
a transmitting unit that is arranged and configured to transmit the first data set to a receiving unit located on the earth.

14. Satellite apparatus according to claim 1, comprising
a compression unit that is arranged and configured to generate a second compressed data set representing the streak images, wherein the second compressed data set can be transmitted by means of one or the transmission unit to a receiving unit located on the earth.

15. A method for imaging space objects, comprising the steps of:
moving a satellite apparatus along an orbit with a position-dependent orbital coordinate system that has an orbital axis, a gravitational axis and a pitch axis, the satellite apparatus comprising a telescope device having a field of view, a telescope axis and an imaging telescope sensor for generating images of space objects in front of the star background,
setting a predetermined pitch angle between the telescope axis and the orbit axis, and
continuously generating streak images of space objects and stars to obtain a plurality of streak images for generating a space object position map.

16. A method according to claim 15, comprising the step of:
adjusting a yaw angle of the telescope axis about the gravitational axis so that the field of view can be aligned with at least one predetermined orbital regime.

17. A method according to claim 16, wherein adjusting the pitch angle and/or performing the yaw motion is effected by changing the position of the satellite apparatus.
